(19) United States
(12) Patent Application Publication
(10) Pub. No.: US 2014/0103897 A1
(43) Pub. Date: Apr. 17, 2014

(54) GLITCH SUPPRESSION IN DC-TO-DC POWER CONVERSION

(71) Applicant: QUALCOMM INCORPORATED, San Diego, CA (US)

(72) Inventors: Le Wang, San Diego, CA (US); Xiaohong Quan, San Diego, CA (US); Vijayakumar Dhanasekaran, San Diego, CA (US); Omid Shoaei, San Diego, CA (US)

(73) Assignee: QUALCOMM INCORPORATED, San Diego, CA (US)

(21) Appl. No.: 13/654,341

(22) Filed: Oct. 17, 2012

(51) Int. Cl. G05F 3/08

(52) U.S. Cl. 323/311

(57) ABSTRACT

Exemplary embodiments are directed to devices and method for operating a charge pump. A method may include activating a first switch coupled between a capacitor and a ground voltage over a first period of a charging phase. The first period may coincide with a non-overlapping time between the charging phase and an output phase. The method may also include activating a second switch coupled between the capacitor and an input voltage over a second period of the charging phase, wherein the first period begins prior to the second period. Further, the method may include deactivating the second switch over a third period of the charging phase and deactivating the first switch over a fourth period of the charging phase, wherein the third period begins prior to the fourth period.

### BACKGROUND

1. Field

The present invention relates generally to power conversion. More specifically, the present invention relates to systems, devices, and methods for reducing glitches in DC-to-DC power conversion applications.

2. Background

A DC-to-DC converter is a power converter that converts a source of direct current (DC) from one voltage level to another voltage level. DC to DC converters are typically used in electronic devices, such as cellular phones and laptop computers. Such electronic devices may include multiple circuits, each of which may require a different voltage level than a level supplied from a source. As an example, a circuit may require a voltage level that is higher than a voltage level provided by a battery.

A charge pump is a type of DC-to-DC converter that uses capacitors to store and transfer energy to an output at a voltage level, which is either higher or lower than a level of a received input voltage. In DC-to-DC power conversion applications, a charge pump based on switched-capacitors is conventionally used to generate multiple supply voltages.

In switched capacitor-based DC-to-DC converters, such as a negative charge pump, the activation and deactivation of switches may result in large current changes in the parasitic inductance along the paths connecting off-chip capacitors. Resulting voltage spikes, which may appear at the output of a DC-to-DC converter, may affect not only the supply headroom, but also the harmonic distortion performance of the converter. Conventional solutions for suppressing charge pump output glitches rely on slowing down clock transition edges, which adversely increases the turn-on resistance of the switches and, therefore, the efficiency of the charge pump. In addition, solutions that use a large capacitor (i.e., around several hundred picofarads) to hold an output voltage require a large silicon area, which is undesirable.

A need exists for methods, systems, and devices for enhancing output glitch suppression techniques for switched capacitor-based DC-to-DC power converters.

### BRIEF DESCRIPTION OF THE DRAWINGS

FIG. 1A illustrates a power conversion circuit including a capacitor and a plurality of switches.

FIG. 1B illustrates the power conversion circuit of FIG. 1A during a charging phase.

FIG. 1C illustrates the power conversion circuit of FIG. 1A during an output phase.

FIGS. 2A and 2B illustrate terminal voltage changes during a charging phase of a power conversion circuit.

FIG. 3A is an RLC circuit.

FIG. 3B is a plot illustrating a capacitor voltage of the RLC circuit of FIG. 3A.

FIG. 3C is a plot illustrating a capacitor current of the RLC circuit of FIG. 3A.

FIG. 4 is a timing diagram depicting operational states of various switches of a DC-to-DC converter, according to an exemplary embodiment of the present invention.

FIG. 5A illustrates a latch-based circuit for advancing an edge of a non-overlapping clock, according to an exemplary embodiment of the present invention.

FIG. 5B illustrates a plurality of clock signals associated with the latch-based circuit of FIG. 5A.

FIG. 6 is a plot illustrating various waveforms associated with a DC-to-DC converter.

FIG. 7 is another plot illustrating various waveforms associated with a DC-to-DC converter.

FIG. 8 is a flowchart illustrating a method, in accordance with an exemplary embodiment of the present invention.

FIG. 9 is a flowchart illustrating another method, according to an exemplary embodiment of the present invention.

FIG. 10 is a flowchart illustrating yet another method, according to an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

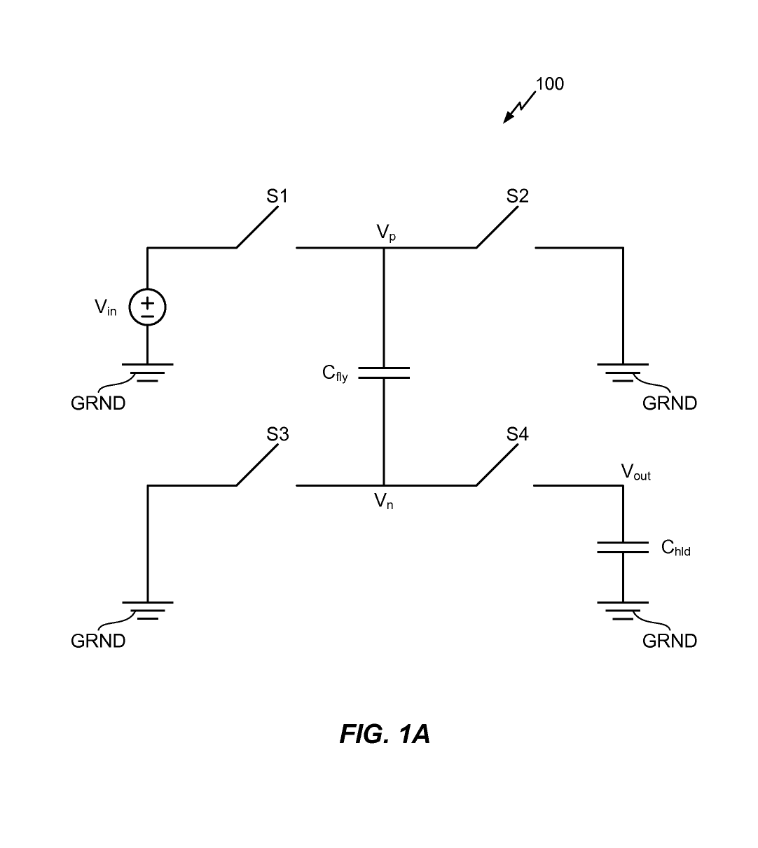

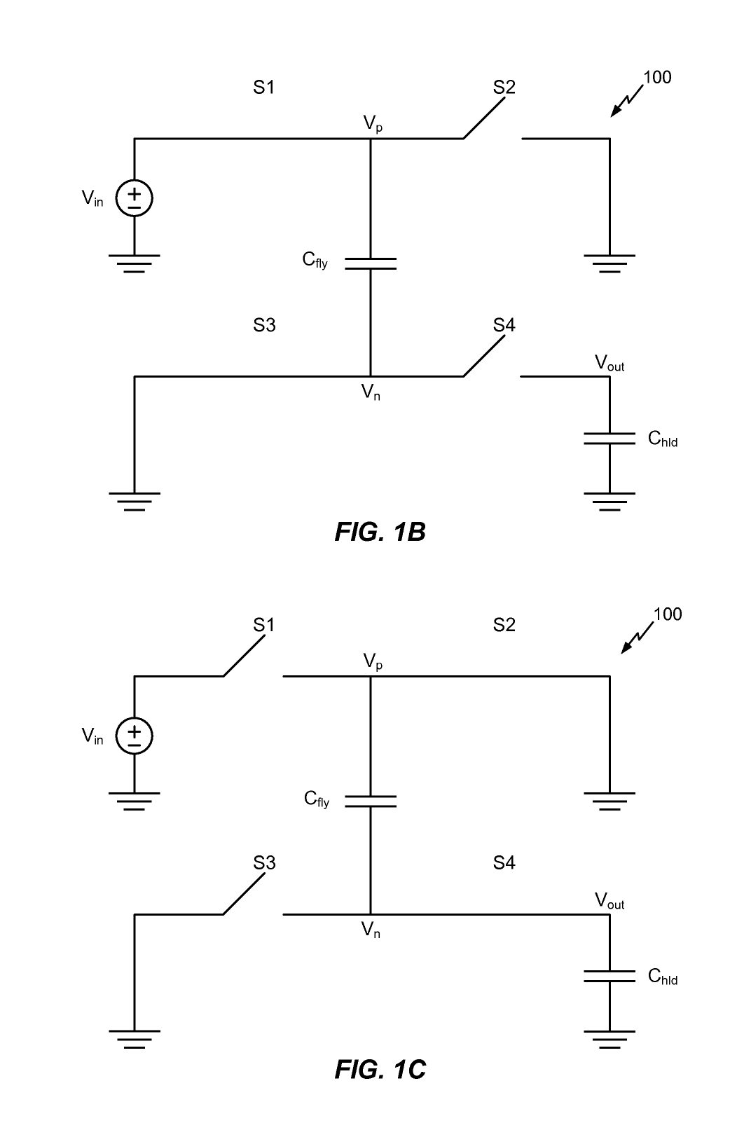

FIG. 1 illustrates a circuit 100 for converting a supply voltage Vᵢₙ to an output voltage Vₒᵤₜ, which may have a voltage level that is either higher or lower than a voltage level of supply voltage Vin. Circuit 100 includes a flying capacitor C_{fly}, an output holding capacitor C_{hld}, and a plurality of switches S1-S4. More specifically, circuit 100 includes a first switch S1 configured for coupling supply voltage Vᵢₙ to a first terminal of flying capacitor C_{fly} and a second switch for coupling the first terminal of flying capacitor C_{fly} to a ground voltage GRND. In addition, circuit 100 includes a third switch S3 for coupling a second terminal of flying capacitor C_{fly} to ground voltage GRND and a fourth switch S4 for coupling the second terminal of flying capacitor C_{fly} to output holding capacitor C_{hld}.

As will be understood by a person having ordinary skill in the art, power conversion circuits, such as circuit 100, may comprise a multi-phase circuit. With reference to FIGS. 1A and 1B, during a first phase of operation (i.e., a charging phase), flying capacitor C_{fly} may be charged to a level of supply voltage Vin by closing switches S1 and S3 and opening switches S2 and S4. As illustrated in FIG. 1B, during the first phase (i.e., the charging phase), the first terminal of flying capacitor C_{fly} is coupled to supply voltage Vin and the second terminal of flying capacitor C_{fly} is coupled to ground voltage GRND. Further, with reference to FIGS. 1A and 1C, during a second phase of operation (i.e., an output phase) of circuit 100, output voltage Vₒᵤₜ may be generated by closing switches S2 and S4 and opening switches S1 and S3. As illustrated in FIG. 1C, during the second phase, the first terminal of flying capacitor C_{fly} is coupled to ground voltage GRND and the second terminal of flying capacitor C_{fly} is coupled to output holding capacitor C_{hld}. As will be appreciated, circuit 100 reverses a polarity of a charge and, therefore, a negative voltage is provided at output voltage Vₒᵤₜ.

As will be understood by a person having ordinary skill in the art, a negative charge pump is a large current switching circuit. Therefore, any parasitic inductance in a signal path can produce terminal voltage rippling when a switch is turned on and residual current sloshing when the switch is turned off, resulting in glitches at an output node. As noted above, output glitches may limit power amplifier headroom causing supply clipping, affect the power amplifier noise and harmonic distortion performance, or both. When the negative charge pump has a changing input, the charging current also tends to increase the glitch voltage.

Exemplary embodiments, as described herein, are directed to suppressing glitches in a DC-to-DC power converter. It is noted that although exemplary embodiments of the present invention are described with circuit 100, the present invention is not so limited. Rather, the present invention may be applicable to any suitable power conversion circuit. For example, the exemplary embodiments described herein may be applicable to any switched-capacitor based DC-to-DC power converters. Further, the present invention may be applicable to any switch-mode power supply, such as a buck converter, boost converter, and a fly-back converter. According to one exemplary embodiment of the present invention, clock edge information may be used to properly time on/off transitions of switches in a two-phase negative charge pump to suppress the output glitches. More specifically, in accordance with one exemplary embodiment, when switching into either a charging phase or an output phase, a non-overlapping time existing between charging and output phases can be used to gradually “turn on” (i.e., activate) a ground switch in advance, and then an associated input or output switch may be turned on (i.e., activated). Further, when switching out of either a charging phase or an output phase, slower input or output switch may be gradually “turned off” (i.e., deactivated), and then an associated ground switch can be turned off (i.e., deactivated). As described more fully below, the input and output switches, which are deactivated relatively slowly, may be deactivated in a two-step process. Stated another way, a master portion of a switch may be deactivated relatively quickly, and then a second portion of the switch may be deactivated relatively slowly.

A glitch voltage may also be reduced by minimizing the parasitic inductance via proper PCB design and chip layout. To reduce routing inductance, a signal trace needs to be widen as much as possible and the underlying ground plane also needs to be placed as close as possible. In addition to reducing parasitic inductance, the charging/discharging current may be distributed over longer durations to reduce glitch voltage. High frequency noise may be filtered out, and low frequency noise may produce a lesser amount of glitch voltage.

A negative charge pump design may have four different transitions in each clock cycle: connect to input switch (i.e., begin charging phase); disconnect from input switch (i.e., end charging phase); connect to output switch (i.e., being output phase); and disconnect from output switch (i.e., end output phase). Each transition has different mechanisms for producing output glitches, so different methods have been devised to mitigate these glitches.

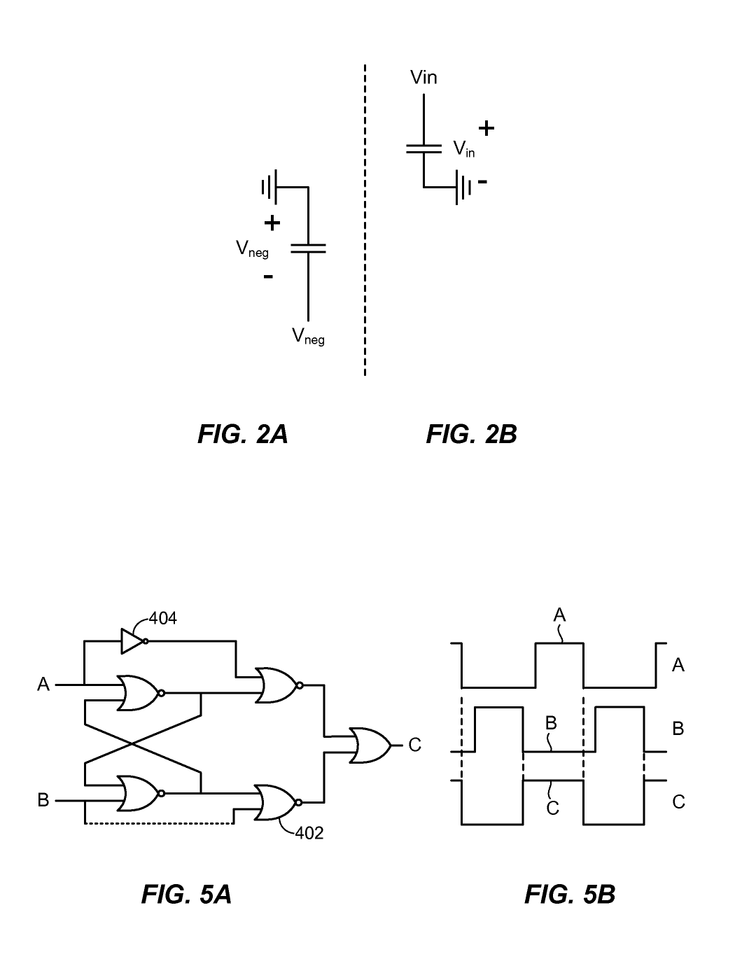

FIGS. 2A and 2B illustrate changes in a terminal voltage of a flying capacitor (e.g., flying capacitor C_{fly} illustrated in FIG. 1A) during a charging phase of a DC-to-DC power conversion. FIG. 2A illustrates a terminal voltage prior to connecting a flying capacitor to an input voltage and FIG. 2B illustrates the terminal voltage after the input voltage has been connected to the flying capacitor. As will be appreciated, a voltage step occurs at both terminals of a flying capacitor, forming a second order RLC damping circuit. The terminal voltage is expressed below in equation (1).

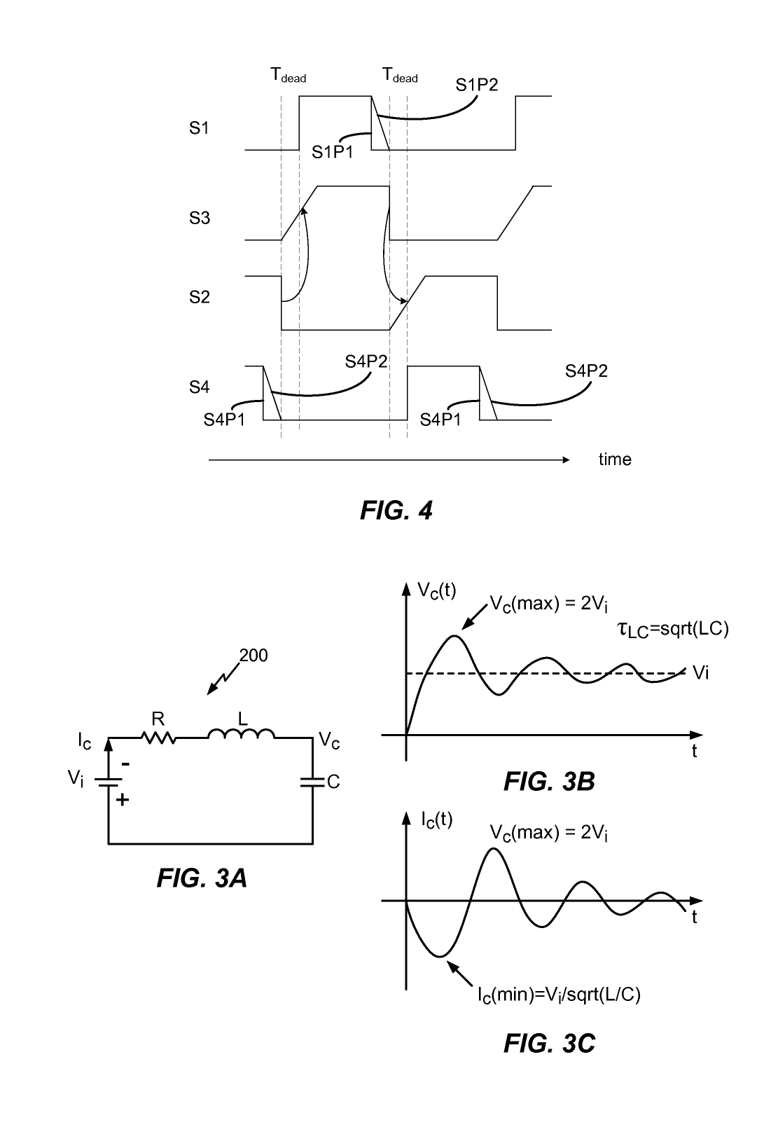

FIG. 3A is an RLC circuit 200, FIG. 3B is a plot illustrating a capacitor voltage of RLC circuit 200 over time, and FIG. 3C is a plot illustrating a capacitor current of RLC circuit 100 over time. A time constant of an RLC ring is determined by the parasitic inductance and the flying capacitor, and the damping factor is determined by the total path resistance. It may be difficult to increase the resistance due to the efficiency requirement of a negative charge pump. Therefore, the peak voltage Vx can reach 2 Vi, and this peak voltage ac-couples to an output of the negative charge pump through the diffusion capacitance in the output switch (e.g., switch S4 illustrated in FIG. 1A).

Vₓ=Vᵢ└1−e^{-Rt/2L} cos(t\sqrt{1/LC−R²/4L²})┘ (1)

Equation (2) shows a maximum peak voltage V_{x,max} in a first period (e.g., a first period of a charging phase), which is dependent on an initial voltage difference and the damping factor ξ. By slowing down the clock transition in the first period, the damping factor can be increased, and therefore, the peak voltage and oscillation cycles can be decreased.

$${V}_{x , ma x} = {V}_{i} [ 1 + exp ( \frac{- π ξ}{\sqrt{1 - {ξ}^{2}}} ) ] \qquad ( 2 )$$

Exemplary embodiments may reduce, and possibly eliminate glitches during operation of a charge pump. FIG. 4 illustrates a timing diagram depicting operational states of switches S1, S2, S3, and S4. As illustrated in FIG. 4, a non-overlapping time period “T_{dead}” exists between clock phases. Stated another way, non-overlapping time period T_{dead} exists after an output phase ends and before a charging phase begins. Further, non-overlapping time period T_{dead} exists after a charging phase ends and before an output phase begins. According to various exemplary embodiments described herein, for rising edges, a ground switch (e.g., switch S2 or switch S3) may be slowly activated during non-overlapping time period T_{dead}, and then an associated switch (i.e., input switch S1 or output switch S4) may be activated. Further, for falling edges, a switch (i.e., input switch S1 or output switch S4) may be slowly deactivated, and then an associated ground switch (e.g., switch S2 or switch S3) may be quickly deactivated.

With reference to FIGS. 1A and 4, a method of reducing glitches during initiation of a charging phase of a negative charge pump will now be described. To initiate a charging phase (i.e., either upon disconnecting flying capacitor C_{fly} from an output path (i.e., deactivating an output phase)) upon initial activation of circuit 100) a ground switch (i.e., switch S3) can may turned on to slowly increase the flying capacitor voltage. It is noted that the ground switch (i.e., switch S3) may be turned on slightly earlier than an input switch (i.e., switch S1). This operation may “bootstrap” a terminal voltage of flying capacitor C_{fly} close to input voltage Vᵢₙ. Stated another way, a voltage level on the first terminal (i.e., the terminal coupled to voltage Vₚ) of a flying capacitor (e.g., flying capacitor C_{fly}) may be driven toward a level of an input voltage (e.g., Vᵢₙ). When input switch S1 is turned on (i.e., activated), a steady-state voltage step will be relatively small, similar to an AC ripple, which is usually less than 100 mV. Stated another way, a terminal voltage difference may be decreased, which will result in a decreased glitch voltage in the settling process. In order avoid sacrificing the efficiency of a negative charge pump, non-overlapping time T_{dead} may be utilized to bootstrap the flying capacitor voltages.

FIG. 5A illustrates a RS latch-based circuit 400 to advance the rising edge of non-overlapping clock. A NOR gate 402 ensures that the high-to-low transition on clock B triggers a low-to-high transition on an output C. An inverter gate 404 is utilized to synchronize the output high-to-low transition with main input clock A. FIG. 5B is a timing diagram depicting various signals associated with circuit 400. According to an exemplary embodiment of the present invention, when clock A, which may comprise a main clock, transitions from high to low, clock C, which comprises a ground switch (i.e., switch S2 or switch S3), transitions from high to low and, therefore, the ground switch is turned off. Further, when clock B, which may comprise a feedback clock, transitions from high to low, clock C, which comprises the ground switch (i.e., switch S2 or switch S3), transitions from low to high and, therefore, the ground switch is turned on.

In conventional systems, due to insufficient settling, a certain amount of residual current may exist in the parasitic inductor when flying capacitor C_{fly} is disconnected from the input switch (i.e., when input switch S1 is deactivated). The residual current may be in the range of a couple of hundred of mA, even more during an input ramp-up. Depending on how fast input switch S1 is turned off (i.e., deactivated), the residual current may produces large Ldi/dt voltage on internal nodes and couples to the output through the parasitic capacitance of M4 switch. Further, this glitch voltage may occur on top of an AC ripple, so it may have a more noticeable effect on the supply headroom.

With continued reference to FIGS. 1A and 4, a method of reducing glitches during deactivation of charging phase of a negative charge pump will now be described. According to one exemplary embodiment, input switch S1 may comprise a plurality of portions. As one example, input switch S1 may comprise a first portion, which may comprise, for example, 95% of switch S1 and a second portion, which may comprise 5% of switch S2. As illustrated in FIG. 4, deactivation of switch S1 may comprise a two-step process. More specifically, a first portion S1P1 of switch S1 may be turned off relatively quickly, and a second portion S1P2 of switch S1 may be turned off relatively slowly. Further, deactivation of switch S4 may also comprise a two-step process. More specifically, a first portion S4P1 of switch S4 may be turned off relatively quickly, and a second portion S4P2 of switch S4 may be turned off relatively slowly. As another example, input switch S1 may comprise eight portions with a size order of 16-8-4-2-1-1-1-1. The larger switch portions may be turned off at a faster pace than the smaller portions. Further, ground switch S3 may be quickly turned off (i.e., deactivated) after deactivating input switch S1. Stated another way, input switch S1 is slowly turned off in advance, and then ground switch S3 is turned off By doing so, the DC path is still maintained while its path resistance is gradually increased. Accordingly, the residual current may be evenly distributed in a longer duration. Moreover, the increased path resistance dampens the Ldi/dt oscillation and high frequency glitches may be filtered out.

In conventional systems when initiating an output phase (i.e., when activating switches S2 and S4 and deactivating switches S1 and S3), the parasitic inductor current will gradually reverse current direction. Stated another way, before initiating an output phase, load current flows into holding capacitor C_{hld}. After initiating the charging phase, both the inductor current and the load current flow into flying capacitor C_{fly}. This current reversion may results in an output Ldi/dt glitch on top of the AC ripple. With continued reference to FIGS. 1A and 4, a method of reducing glitches upon initiating an output phase of a negative charge pump will now be described. According to one exemplary embodiment, ground switch S2 may be slowly activated during non-overlapping time T_{dead}, and then output switch S4 may be activated. This operation may “bootstrap” a terminal voltage of flying capacitor C_{fly} close to output voltage Vₒᵤₜ. Stated another way, a voltage level on the second terminal (i.e., the terminal coupled to voltage Vₙ) of a flying capacitor (e.g., flying capacitor C_{fly}) may be driven toward a level of an output voltage (e.g., Vₒᵤₜ). When input switch S4 is turned on (i.e., activated), a steady-state voltage step will be decreased relative to conventional methods.

In conventional systems, upon turning off (i.e., deactivating) an output phase (i.e., deactivating switches S2 and S4), the parasitic inductor current will reverse current direction. Stated another way, during an output phase, both the inductor current and the load current flow into flying capacitor C_{fly}. After deactivating the output phase, load current flows into holding capacitor C_{hld}. This current reversion may result in an output Ldi/dt glitch at the bottom of an AC ripple.

With continued reference to FIGS. 1A and 4, a method of reducing glitches during deactivation of an output phase of a negative charge pump will now be described. According to one exemplary embodiment, switch S4 can be turned off earlier than the switch S2 since switch S2 is a much faster device. In addition, switch S4 may be split into a plurality of portions, such as a master portion and a small portion. As one example, the master portion may comprise 95% of switch S4 and the small portion may comprise 5% of switch S4. As another example, the master portion may comprise 98% of switch S4 and the small portion may comprise 2% of switch S4. The master portion may be quickly turned off while the small portion is still on to maintain a high resistance current path. By the time the master portion is turned off, most of the load current is shunt into a parasitic inductor. When the small portion is slowly turned off, it may be much smoother to shunt the residual load current into the parasitic inductor, resulting in much smaller glitch voltage. Switch S2 may then be quickly turned off to save non-overlapping time.

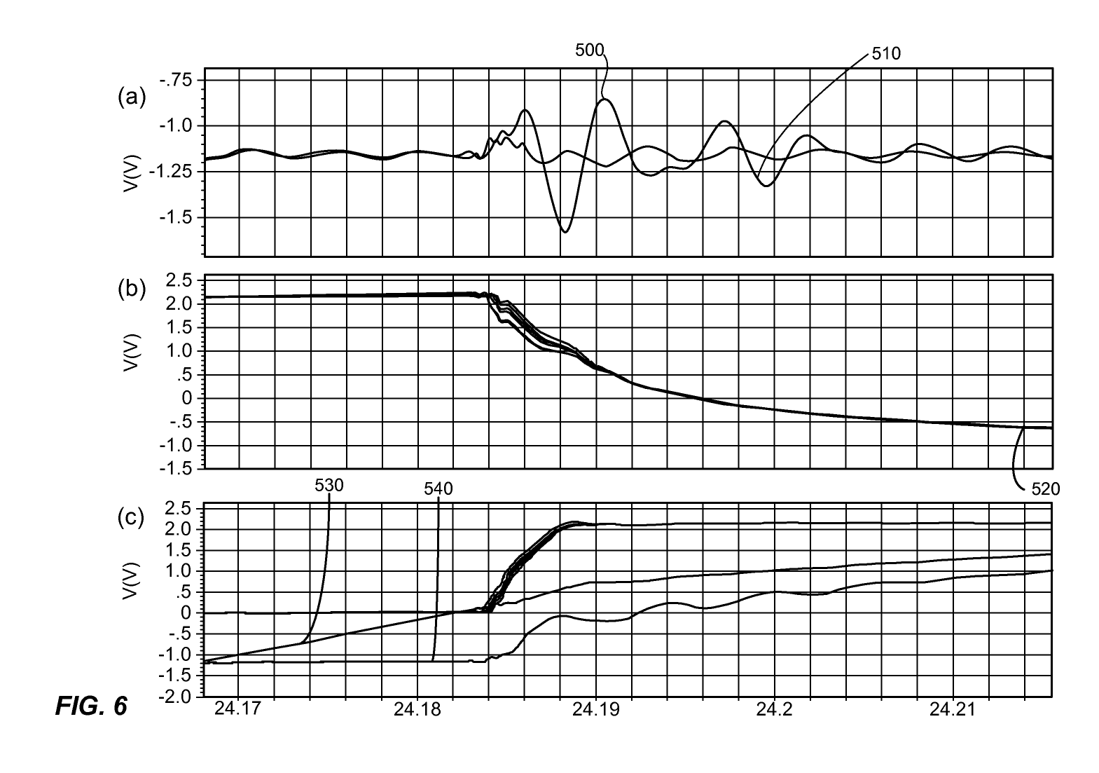

FIGS. 6(a)-(c) are plots illustrating simulation results of a negative charge pump. With respect to FIG. 6(a), an output glitch 500 without a bootstrapping method includes a relatively high peak glitch. In comparison, an output glitch 510 generated with a bootstrapping method, in accordance with exemplary embodiments of the present invention, may have a lower peak glitch. With reference to FIG. 6(b) a signal 520 depicts a clock waveform of switch S1. Further, a signal 530 of FIG. 6(c) depicts a clock waveform of switch S3 with an advance rising edge and a signal 540 of FIG. 6(c) depicts a clock waveform of switch S3 without an advance rising edge.

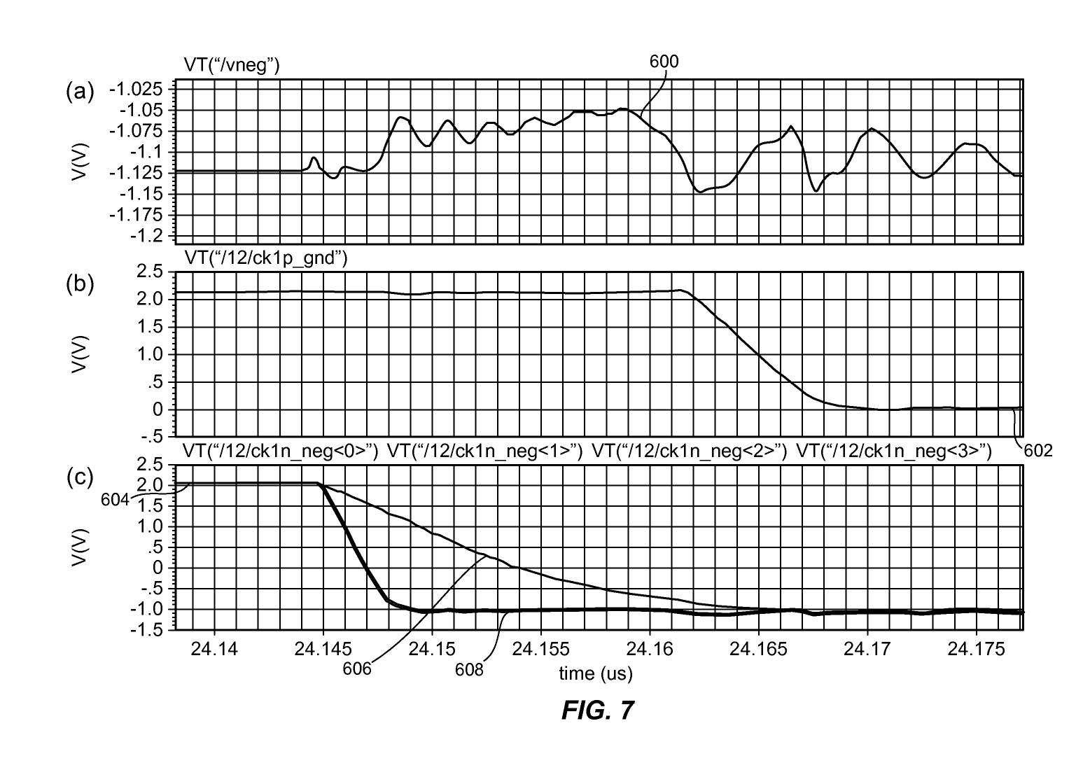

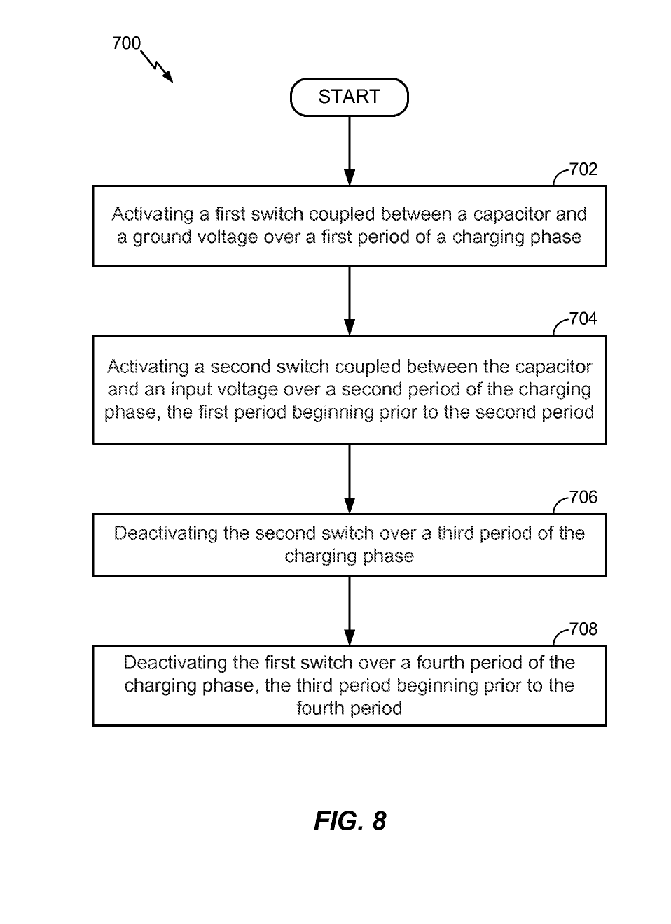

FIGS. 7(a)-(c) are plots illustrating simulation results including various signals associated with deactivation of an output phase of a negative charge pump. A signal 600 in FIG. 7(a) depicts an output voltage having a relatively small output glitch. A signal 604 in FIG. 7(c) depicts an operational state of an output switch (e.g., switch S4) having a large portion 606 and a small portion 608. Further, a signal 610 in FIG. 7(b) depicts an operational state of a ground switch (e.g., switch S2). As illustrated in FIG. 6, the output switch begins to turn off prior to the ground switch.

FIG. 8 is a flowchart illustrating a method 700, in accordance with one or more exemplary embodiments. Method 700 may include activating a first switch (e.g., switch S3 of FIG. 1A) coupled between a capacitor and a ground voltage over a first period of a charging phase (depicted by numeral 702). It is noted that the first switch may be activated relatively slowly by slowing down the relevant clock edge. It is further noted that the first period may comprise a non-overlapping time or “dead time” between a discharging phase and a charging phase. Method 700 may also include activating a second switch (e.g., switch S1 of FIG. 1A) coupled between the capacitor and an input voltage over a second period of the charging phase, the first period beginning prior to the second period (depicted by numeral 704). In one exemplary embodiment, the second period may comprise a period wherein the capacitor is charged by the input voltage. In addition, method 700 may include deactivating the second switch over a third period of the charging phase (depicted by numeral 706). According to one exemplary embodiment, the second switch may include two portions (i.e., one relatively large portion and one relatively small portion). The large portion may be turned off (i.e., deactivated) relatively fast and then the small portion may be turned off (i.e., deactivated) relatively slowly. Furthermore, method 700 may include deactivating the first switch over a fourth period of the charging phase, the third period beginning prior to the fourth period (depicted by numeral 708). According to one embodiment, the first switch may be deactivated relatively fast.

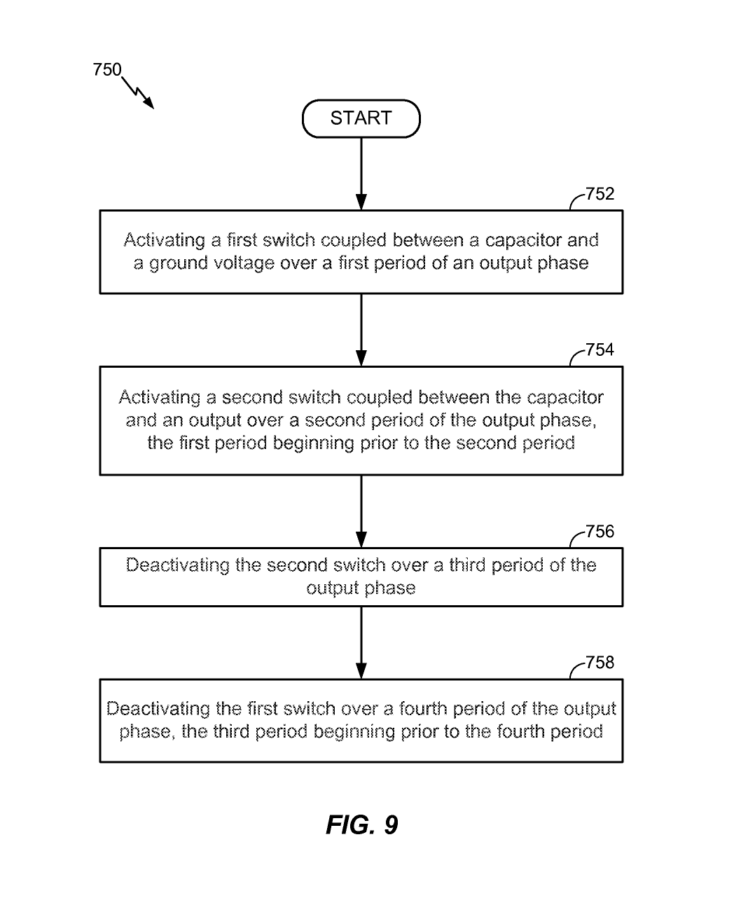

FIG. 9 is a flowchart illustrating another method 750, in accordance with one or more exemplary embodiments. Method 750 may include receiving activating a first switch (e.g., switch S2 of FIG. 1A) coupled between a capacitor and a ground voltage over a first period of an output phase (depicted by numeral 752). Further, method 750 may include activating a second switch (e.g., switch S4 of FIG. 1A) coupled between the capacitor and an output over a second period of the output phase, the first period beginning prior to the second period (depicted by numeral 754). Additionally, method 750 may include deactivating the second switch over a third period of the output phase (depicted by numeral 756). Moreover, method 750 may include deactivating the first switch over a fourth period of the output phase, the third period beginning prior to the fourth period (depicted by numeral 758).

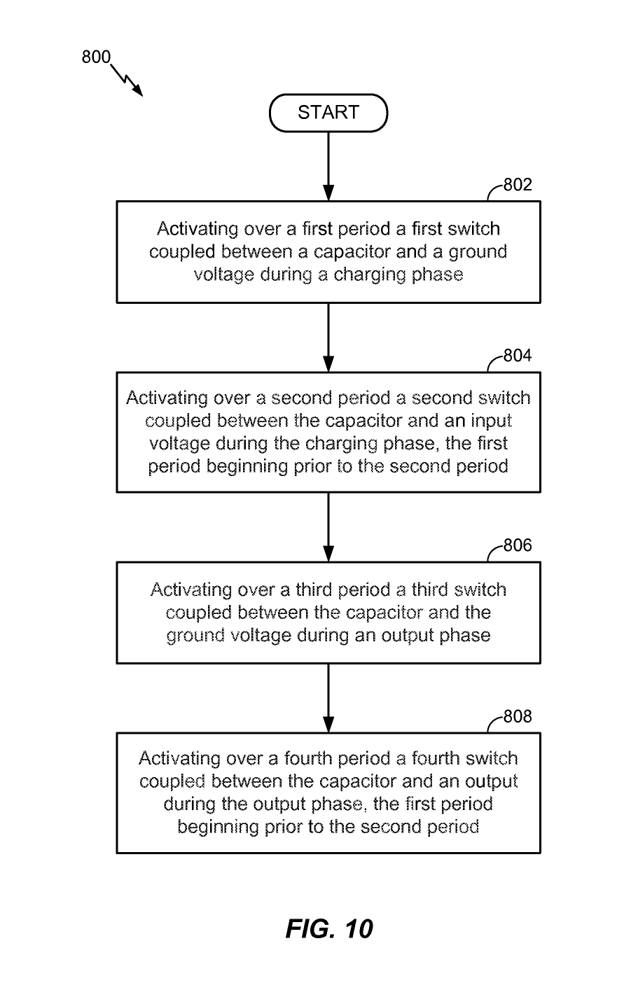

FIG. 10 is a flowchart illustrating another method 800, in accordance with one or more exemplary embodiments. Method 800 may include activating over a first period a first switch (e.g., switch S3 of FIG. 1A) coupled between a capacitor and a ground voltage during a charging phase (depicted by numeral 802). Further, method 800 may include activating over a second period a second switch (e.g., switch S1 of FIG. 1A) coupled between the capacitor and an input voltage during the charging phase, the first period beginning prior to the second period (depicted by numeral 804). Additionally, method 800 may include activating over a third period a third switch (e.g., switch S2 of FIG. 1A) coupled between the capacitor and the ground voltage during an output phase (depicted by numeral 806). Moreover, method 800 may include activating over a fourth period a fourth switch (e.g., switch S4 of FIG. 1A) coupled between the capacitor and an output during the output phase, the first period beginning prior to the second period (depicted by numeral 808).

It is noted that compared to conventional methods, the methods described herein do not sacrifice switch-on time and hence the output efficiency. In addition, described methods do not require an additional de-coupling capacitor, which undesirably increases silicon area overhead.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method, comprising:
activating a first switch coupled between a capacitor and a ground voltage over a first period of a charging phase;
activating a second switch coupled between the capacitor and an input voltage over a second period of the charging phase, the first period beginning prior to the second period;
deactivating the second switch over a third period of the charging phase; and
deactivating the first switch over a fourth period of the charging phase, the third period beginning prior to the fourth period.

2. The method of claim 1, wherein activating the first switch comprises activating the first switch at a first rate and activating the second switch comprises activating the second switch at a second, faster rate.

3. The method of claim 1, wherein deactivating the second switch comprises deactivating the second switch at a first rate and deactivating the first switch comprises deactivating the first switch at a second, faster rate.

4. The method of claim 1, wherein activating the first switch coupled to a first plate of the capacitor drives a second, opposite plate of the capacitor toward the input voltage.

5. The method of claim 1, wherein activating the first switch comprises activating a ground switch of a charge pump and activating the second switch comprises activating an input switch of the charge pump.

6. The method of claim 1, wherein activating the first switch comprises activating the first switch during a non-overlapping time period between an output phase and the charging phase.

7. The method of claim 1, wherein deactivating the second switch comprises deactivating the second switch in a multi-step process.

8. A method, comprising:
activating a first switch coupled between a capacitor and a ground voltage over a first period of an output phase;
activating a second switch coupled between the capacitor and an output over a second period of the output phase, the first period beginning prior to the second period;
deactivating the second switch over a third period of the output phase;
deactivating the first switch over a fourth period of the output phase, the third period beginning prior to the fourth period.

9. The method of claim 8, wherein activating the first switch comprises activating the first switch at a first rate and activating the second switch comprises activating the second switch at a second, faster rate.

10. The method of claim 8, wherein deactivating the second switch comprises deactivating the second switch at a first rate and deactivating the first switch comprises deactivating the first switch at a second, faster rate.

11. The method of claim 8, wherein activating the first switch coupled to a first plate of the capacitor drives a second, opposite plate of the capacitor toward a voltage at the output.

12. The method of claim 8, wherein activating the first switch comprises activating a ground switch of a charge pump and activating the second switch comprises activating an output switch of the charge pump.

13. The method of claim 8, wherein activating the first switch comprises activating the first switch during a non-overlapping time period between a charging phase and the output phase.

14. The method of claim 8, wherein deactivating the second switch comprises deactivating the second switch in a multi-step process.

15. A method, comprising:
activating over a first period a first switch coupled between a capacitor and a ground voltage during a charging phase;
activating over a second period a second switch coupled between the capacitor and an input voltage during the charging phase, the first period beginning prior to the second period;
activating over a third period a third switch coupled between the capacitor and the ground voltage during an output phase; and
activating over a fourth period a fourth switch coupled between the capacitor and an output during the output phase, the first period beginning prior to the second period.

16. The method of claim 15, wherein activating over the second period comprising activating over the second period having a shorter duration than the first period.

17. The method of claim 15, wherein activating over the fourth period comprising activating over the fourth period having a shorter duration than the third period.

18. The method of claim 15, further comprising:
deactivating the second switch over a fifth period;
deactivation the first switch over a sixth period, the fifth period beginning prior to the sixth period;
deactivating the fourth switch over a seventh period; and
deactivation the third switch over a eighth period, the seventh period beginning prior to the eighth period.

19. The method of claim 18, wherein deactivating the second switch comprises deactivating the second switch at a first rate and deactivating the first switch comprises deactivating the first switch at a second, faster rate.

20. The method of claim 18, wherein deactivating the fourth switch comprises deactivating the fourth switch at a first rate and deactivating the third switch comprises deactivating the third switch at a second, faster rate.

21. The method of claim 15, wherein activating the first switch and activating the second switch comprises activating the first switch and activating the second switch during a non-overlapping time period between the output phase and the charging phase.

22. The method of claim 15, wherein activating the third switch and activating the fourth switch comprises activating the third switch and activating the fourth switch during a non-overlapping time period between the charging phase and the charging output phase.

23. A device, comprising:
means for coupling a capacitor to a ground voltage over a first period of a charging phase;
means for coupling the capacitor to an input voltage over a second period of the charging phase, the first period beginning prior to the second period;
means for decoupling the capacitor from the input voltage over a third period of the charging phase; and
means for decoupling the capacitor from the ground voltage over a fourth period of the charging phase, the third period beginning prior to the fourth period.

24. The device of claim 23, the means for coupling a capacitor to the ground voltage and the means for decoupling the capacitor from the ground voltage comprising a ground switch and the means for coupling the capacitor to an input voltage and the means for decoupling the capacitor from the input voltage comprising an input switch.

25. A device, comprising:
means for coupling a capacitor to a ground voltage over a first period of an output phase;
means for coupling the capacitor to an output over a second period of the output phase, the first period beginning prior to the second period;
means for decoupling the capacitor from the output over a third period of the output phase;
means for decoupling the capacitor from the ground voltage over a fourth period of the output phase, the third period beginning prior to the fourth period.
